(19) United States
(12) Patent Application Publication
(10) Pub. No.: US 2014/0010272 A1
(43) Pub. Date: Jan. 9, 2014

(54) Pilot Signal Cancellation Scheme for Mobile Broadband Systems Based on OFDM

(71) Applicants: Zhangyong Ma, Beijing (CN); Neng Wang, Beijing (CN); Haitong Sun, San Diego, CA (US)

(72) Inventors: Zhangyong Ma, Beijing (CN); Neng Wang, Beijing (CN); Haitong Sun, San Diego, CA (US)

(73) Assignee: QUALCOMM Incorpated, San Diego (CA)

(21) Appl. No.: 13/979,338

(22) PCT Filed: Feb. 14, 2011
(86) PCT No.: PCT/CN2011/070966

§ 371 Date: Sep. 11, 2013

(51) Int. Cl. H04L 27/26

(52) U.S. Cl. CPC H04L 27/2602
USPC 375/224

(57) ABSTRACT

Certain aspects of the present disclosure relate to a technique for pilot based inter-carrier interference (ICI) cancellation in time-varying channel environments, such as wireless mobile broadband systems based on Orthogonal Frequency Division Multiplexing (OFDM).

### BACKGROUND

1. Field

Certain aspects of the present disclosure generally relate to wireless communications and, more particularly, to a pilot signal cancellation scheme for wireless mobile broadband systems based on Orthogonal Frequency Division Multiplexing (OFDM).

2. Background

In Orthogonal Frequency Division Multiplexing (OFDM) systems, time variations of a channel during one OFDM symbol interval may destroy orthogonality of different subcarriers and generate power leakage among the subcarriers, resulting in inter-carrier interference (ICI), which may degrade the performance considerably. To mitigate the effects of channel variations, many schemes have been proposed, but they are either computationally complex or sacrifice spectral efficiency.

In OFDM systems, the entire channel can be divided into many narrow sub-channels, which may be transmitted in parallel, thereby increasing the symbol duration and reducing the inter-symbol interference (ISI). The ISI can be completely eliminated by introducing a cyclic prefix (CP) between adjacent OFDM symbols and ensuring that the length of CP is greater than the length of channel impulse response. If the channel is time-invariant within an OFDM block, a traditional complex time domain equalizer may be replaced by a simple single tap frequency domain equalizer, since the cyclically extended guard interval converts linear convolution of signal and channel into circular convolution.

However, wideband mobile communication systems are expected to operate at high transmit frequencies, at high levels of mobility, and at high capacities, resulting in the channel fading to be both time and frequency-selective. In these cases, channel variations within an OFDM block may destroy the orthogonality of subcarriers, resulting in ICI due to power leakage among subcarriers which may degrade the bit-error rate (BER) performance severely. To mitigate the ICI due to channel variations, many techniques have been proposed, e.g., minimum mean squared error (MMSE), polynomial cancellation coding (PCC), matched filtering, time-domain filtering, Taylor series expansion, and so on. However, due to the high computational complexity, these techniques may not be feasible in practical systems with large number of subcarriers.

### SUMMARY

Certain aspects of the present disclosure provide a method for wireless communications. The method generally includes receiving a sequence of Orthogonal Frequency Division Multiplexing (OFDM) symbols, the OFDM symbols comprising data tones and pilot tones, estimating a channel impulse response (CIR) vector for each of at least three of the OFDM symbols in the sequence, for a plurality of channel paths, based on pilot tones in the at least three OFDM symbols, obtaining, based on the estimated CIR vectors, channel estimates associated with a current one of the at least three OFDM symbols for a set of one or more channel paths from the plurality of channel paths, obtaining a pilot signal based on pilot tones in the current OFDM symbol, wherein the pilot signal covers all tones of the current OFDM symbol, calculating an estimated received pilot signal based on the obtained pilot signal and the channel estimates associated with the current OFDM symbol for the set of one or more channel paths, and subtracting the estimated received pilot signal from received data tones of the current OFDM symbol.

Certain aspects of the present disclosure provide an apparatus for wireless communications. The apparatus generally includes a receiver configured to receive a sequence of Orthogonal Frequency Division Multiplexing (OFDM) symbols, the OFDM symbols comprising data tones and pilot tones, an estimator configured to estimate a channel impulse response (CIR) vector for each of at least three of the OFDM symbols in the sequence, for a plurality of channel paths, based on pilot tones in the at least three OFDM symbols, a first circuit configured to obtain, based on the estimated CIR vectors, channel estimates associated with a current one of the at least three OFDM symbols for a set of one or more channel paths from the plurality of channel paths, a second circuit configured to obtain a pilot signal based on pilot tones in the current OFDM symbol, wherein the pilot signal covers all tones of the current OFDM symbol, a third circuit configured to calculate an estimated received pilot signal based on the obtained pilot signal and the channel estimates associated with the current OFDM symbol for the set of one or more channel paths, and a fourth circuit configured to subtract the estimated received pilot signal from received data tones of the current OFDM symbol.

Certain aspects of the present disclosure provide an apparatus for wireless communications. The apparatus generally includes means for receiving a sequence of Orthogonal Frequency Division Multiplexing (OFDM) symbols, the OFDM symbols comprising data tones and pilot tones, means for estimating a channel impulse response (CIR) vector for each of at least three of the OFDM symbols in the sequence, for a plurality of channel paths, based on pilot tones in the at least three OFDM symbols, means for obtaining, based on the estimated CIR vectors, channel estimates associated with a current one of the at least three OFDM symbols for a set of one or more channel paths from the plurality of channel paths, means for obtaining a pilot signal based on pilot tones in the current OFDM symbol, wherein the pilot signal covers all tones of the current OFDM symbol, means for calculating an estimated received pilot signal based on the obtained pilot signal and the channel estimates associated with the current OFDM symbol for the set of one or more channel paths, and means for subtracting the estimated received pilot signal from received data tones of the current OFDM symbol.

Certain aspects of the present disclosure provide a computer program product. The computer program product generally includes a computer-readable medium comprising code for receiving a sequence of Orthogonal Frequency Division Multiplexing (OFDM) symbols, the OFDM symbols comprising data tones and pilot tones, estimating a channel impulse response (CIR) vector for each of at least three of the OFDM symbols in the sequence, for a plurality of channel paths, based on pilot tones in the at least three OFDM symbols, obtaining, based on the estimated CIR vectors, channel estimates associated with a current one of the at least three OFDM symbols for a set of one or more channel paths from the plurality of channel paths, obtaining a pilot signal based on pilot tones in the current OFDM symbol, wherein the pilot signal covers all tones of the current OFDM symbol, calculating an estimated received pilot signal based on the obtained pilot signal and the channel estimates associated with the current OFDM symbol for the set of one or more channel paths, and subtracting the estimated received pilot signal from received data tones of the current OFDM symbol.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system in accordance with certain aspects of the present disclosure.

FIG. 2 illustrates a block diagram of an access point and a user terminal in accordance with certain aspects of the present disclosure.

FIG. 3 illustrates a block diagram of an example wireless device in accordance with certain aspects of the present disclosure.

FIG. 4 illustrates an example system that facilitates inter-carrier interference (ICI) mitigation in accordance with certain aspects of the present disclosure.

FIG. 5 is a functional block diagram conceptually illustrating example blocks that may be performed at a receiver of a wireless system for mitigating ICI in accordance with certain aspects of the present disclosure.

FIG. 6 illustrates an example pilot signal in time domain in accordance with certain aspects of the present disclosure.

FIG. 7 illustrates an example bit error rate (BER) performance results for a proposed ICI mitigation technique for one value of maximum Doppler frequency of a wireless channel in accordance with certain aspects of the present disclosure.

FIG. 8 illustrates an example BER performance results for the proposed ICI mitigation technique for another value of maximum Doppler frequency of a wireless channel in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various wireless communication networks such as Orthogonal Frequency Division Multiplexing (OFDM) networks, Time Division Multiple Access (TDMA) networks, Frequency Division Multiple Access (FDMA) networks, Orthogonal FDMA (OFDMA) networks, Single-Carrier FDMA (SC-FDMA) networks, Code Division Multiple Access (CDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16 (e.g., WiMAX (Worldwide Interoperability for Microwave Access)), IEEE 802.20, Flash-OFDM®, etc. UTRA, E-UTRA, and GSM are part of Universal Mobile Telecommunication System (UMTS). Long Term Evolution (LTE) and Long Term Evolution Advanced (LTE-A) are upcoming releases of UMTS that use E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). CDMA2000 is described in documents from an organization named “3rd Generation Partnership Project 2” (3GPP2). These various radio technologies and standards are known in the art. For clarity, certain aspects of the techniques are described below for LTE and LTE-A.

An access point (“AP”) may comprise, be implemented as, or known as NodeB, Radio Network Controller (“RNC”), eNodeB (“eNB”), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as an access terminal, a subscriber station, a subscriber unit, a mobile station, a remote station, a remote terminal, a user terminal, a user agent, a user device, user equipment (“UE”), a user station, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects the node is a wireless node. Such wireless node may provide, for example, connectivity for or to a network (e.g., a wide area network such as the Internet or a cellular network) via a wired or wireless communication link.

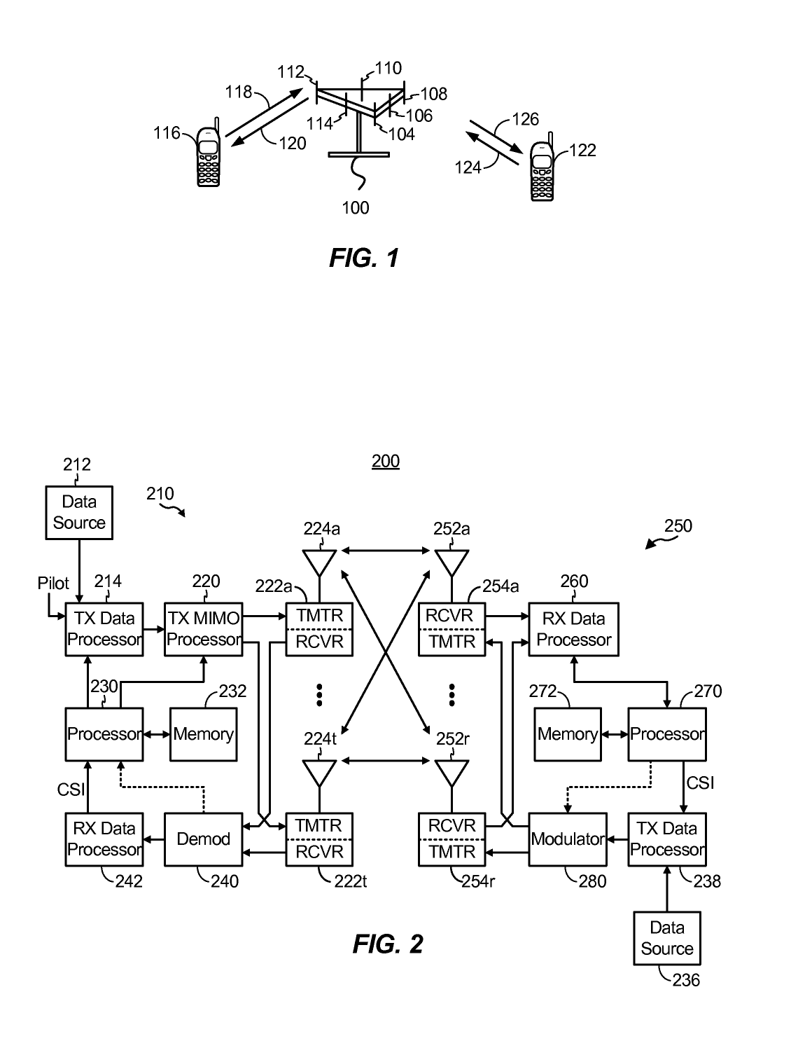

Referring to FIG. 1, a multiple access wireless communication system according to one aspect is illustrated. In an aspect of the present disclosure, the wireless communication system from FIG. 1 may be a wireless mobile broadband system based on Orthogonal Frequency Division Multiplexing (OFDM). An access point 100 (AP) may include multiple antenna groups, one group including antennas 104 and 106, another group including antennas 108 and 110, and an additional group including antennas 112 and 114. In FIG. 1, only two antennas are shown for each antenna group, however, more or fewer antennas may be utilized for each antenna group. Access terminal 116 (AT) may be in communication with antennas 112 and 114, where antennas 112 and 114 transmit information to access terminal 116 over forward link 120 and receive information from access terminal 116 over reverse link 118. Access terminal 122 may be in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In one aspect of the present disclosure each antenna group may be designed to communicate to access terminals in a sector of the areas covered by access point 100.

In communication over forward links 120 and 126, the transmitting antennas of access point 100 may utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

In an aspect of the present disclosure, the wireless communication system illustrated in FIG. 1 may be an OFDM system, where a wireless channel between two communication entities (e.g., the AP 100 and one of the access terminals 116, 122) can be divided into many narrow orthogonal sub-channels (subcarriers), which may be transmitted in parallel, thereby increasing the symbol duration and reducing an inter-symbol interference (ISI). Time variations of a channel between the AP 100 and one of the access terminals 116, 122 during one transmission symbol interval (e.g., OFDM symbol interval) may destroy orthogonality of different subcarriers and generate power leakage among the subcarriers, resulting in inter-carrier interference (ICI), which may degrade the performance considerably. In an aspect of the present disclosure, ICI cancellation may be performed at the access terminal 116 (and/or at the access terminal 122), wherein the proposed ICI cancellation technique may be implemented by reconstructing a pilot signal in time domain that was transmitted from the AP 100 along with data. The reconstructed pilot signal may be then subtracted from received samples before detecting the data signal.

FIG. 2 illustrates a block diagram of an aspect of a transmitter system 210 (also known as the access point) and a receiver system 250 (also known as the access terminal) in a multiple-input multiple-output (MIMO) system 200. At the transmitter system 210, traffic data for a number of data streams is provided from a data source 212 to a transmit (TX) data processor 214.

In one aspect of the present disclosure, each data stream may be transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects of the present disclosure, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals may be received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and further process the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 may be complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights, and then processes the extracted message.

In an aspect of the present disclosure, the ICI cancellation may be performed at the processor 270 of the access terminal 250, wherein the ICI cancellation technique proposed in the present disclosure may be implemented by reconstructing a pilot signal in time domain that was transmitted from the access point 210 along with data. The reconstructed pilot signal may be then subtracted from received samples, at the processor 270, before detecting the data signal.

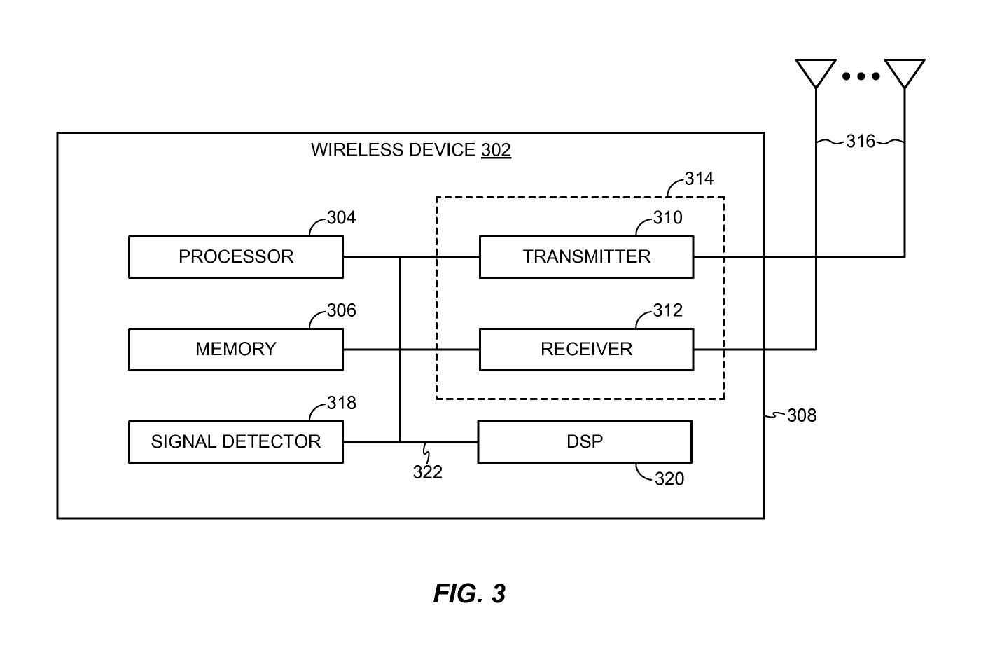

FIG. 3 illustrates various components that may be utilized in a wireless device 302 that may be employed within the wireless communication system from FIG. 1. The wireless device 302 is an example of a device that may be configured to implement the various methods described herein. The wireless device 302 may be an access point 100 from FIG. 1 or any of access terminals 116, 122.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

In an OFDM system in which the wireless device 302 may operate (e.g., as an access terminal), some known symbols, such as pilot symbols, may be inserted (e.g., by an access point) periodically into a data stream in frequency domain enabling coherent detection at a receiver (i.e., at the wireless device 302). According to certain aspects of the present disclosure, mitigating ICI generated by these signals can be performed at the wireless device 302 with a low computational complexity, since some of the transmitted symbols may be known at the receiver and there may not be any error propagation.

A pilot cancellation scheme for OFDM systems in time-varying channel environments is proposed in the present disclosure, which may be implemented by reconstructing the pilot signal in time domain at a receiver (e.g., at the processor 304 of the wireless device 302) and subtracting it before detecting the data signal. Compared with other ICI mitigation schemes from the prior art, the proposed pilot cancellation technique may represent a tradeoff between computational complexity and system performance.

### Pilot Signal Cancellation Scheme for Inter-Carrier Interference Mitigation

An OFDM system with N subcarriers can be considered in the present disclosure, each subcarrier having a bandwidth of Δf. Thus, the overall bandwidth can be B=NΔf. In each OFDM symbol, a vector X={X₀, X₁, . . . , X_{N-1}} may be transmitted with Xₖ being a symbol from a complex valued alphabet with energy E_{S}. The corresponding time domain vector x={x₀, x₁, . . . , x_{N-1}} may be obtained by applying an N-point inverse discrete Fourier transform (IDFT) on the vector X, i.e., x=IDFT{X}. The time domain vector may correspond to a series of time samples, spaced by a sampling period T, wherein T=1/B. Before transmitting the signal, a cyclic prefix (CP) of G samples of the time domain vector may be inserted. The length of CP may be chosen to be larger than the maximum delay spread τₘₐₓ, i.e., GT>τₘₐₓ, to prevent inter-symbol interference (ISI).

For comb-type pilot based channel estimation, which may satisfy the requirement for equalizing when the channel changes even in one OFDM block estimation, a total of M pilot symbols {aₙ;0≦n≦M−1} with energy Eₚ may be uniformly inserted into X at known locations {iₙ=nD_{f};0≦n≦M−1}, where D_{f}=N/M represents a pilot spacing. According to the sampling theorem, the inserted frequency may fulfill the following requirement:

$${D}_{f} < \frac{NT}{{τ}_{max}} \qquad ( 1 )$$

In practical systems, the energy of pilot symbols may be varied with respect to that of data symbols in order to reduce estimation errors. At a receiver, when synchronization is perfect, a received signal with removed CP for each OFDM symbol in a time-varying channel may be expressed by:

$$\begin{matrix}{y}_{n} = {\sum }_{l = 0}^{L - 1} {h}_{l} ( n ) {x}_{{( ( n - l ) )}_{N}} + {w}_{n} & 0 \leq n \leq N - 1\end{matrix} \qquad ( 2 )$$

where L is the number of resolvable channel paths, ((•))_{N} represents a cyclic shift in the base of N, wₙ represents a sample of additive white Gaussian noise, and hₗ(n) denotes the l-th channel path at a time instant t=n×T which can be modeled as a zero-mean complex Gaussian random variable with E{hₗ(n)hₘ*(i)}=0 for l≠m and E{hₗ(n)|²}=σₗ².

Then, Y, the fast Fourier transform (FFT) of the sequence y defined by equation (2), may be written in a matrix form as:

Y=HX+W (3)

where Y=[Y₀, . . . , Y_{N-1}]^{T}, X=[X₀, . . . , X_{N-1}]^{T}, W=[W₀, . . . , W_{N-1}]^{T} and

$$\begin{matrix}H = [ \begin{matrix}{a}_{0 , 0} & {a}_{0 , 1} & … & {a}_{0 , N - 1} \\ {a}_{1 , 0} & {a}_{1 , 1} & … & {a}_{1 , N - 1} \\ ⋮ & ⋮ & ⋱ & ⋮ \\ {a}_{N - 1 , 0} & {a}_{N - 1 , 1} & … & {a}_{N - 1 , N - 1}\end{matrix} ] \\ with & ( 4 ) \\ {a}_{m , k} = {\sum }_{l = 0}^{L - 1} {H}_{l} ( m - k ) {e}^{- j2π kl / N} , & ( 5 ) \\ {H}_{l} ( m - k ) = \frac{1}{N} {\sum }_{n = 0}^{N - 1} {h}_{l} ( n ) {e}^{- j 2 π ( m - k ) n / N} . & ( 6 )\end{matrix}$$

In equations (3)-(6), W represents the zero-mean complex Gaussian noise vector with an autocorrelation matrix N₀I_{N}, i.e., W˜N(0,N₀I_{N}) where N₀ is the noise variance, and Hₗ(m−k) is the FFT of a time-variant multipath channel hₗ(n). In a fast fading channel, the non-vanished term {a_{m,k}} for m≠k may introduce ICI, which may increase the error floor in proportion to the Doppler frequency.

The channel estimates at pilot subcarriers based on Least Square (LS) criterion may be calculated as:

$${\hat{H}}_{{i}_{n}} = \frac{{Y}_{{i}_{n}}}{{a}_{n}} , \qquad ( 7 )$$

where Yᵢ_{ₙ} and aₙ are the output and input at the n-th pilot subcarrier, respectively (i.e., received pilot tones and known pilots at a receiver). For the discrete Fourier transform (DFT) based channel estimation method, a channel impulse response (CIR) may be estimated through:

ĥ_{DFT}=[ĥ₀, . . . , ĥ_{G-1}]^{T}=(F₁^{H}F₁)⁻¹F₁^{H}Ĥ_{LS}, (8)

where a length of the CIR vector may be equal to a length of the CP, Ĥ_{LS}=[Ĥᵢ_{₀}, Ĥᵢ_{₁}, . . . , Ĥᵢ_{ₘ₋₁}]^{T}, and F₁ is a modified DFT matrix retaining only the first G columns and those rows corresponding to the pilot subcarrier positions. In other words, the (p,q)^{th} element of F₁ may be given by:

$${[ {F}_{1} ]}_{p , q} = {e}^{\frac{j 2 π pq}{N}} , for p = {i}_{0} , {i}_{1} , … , {i}_{M - 1} and q = 0 , 1 , … , G - 1. \qquad ( 9 )$$

Then, the channel frequency response (CFR) for all the subcarriers may be given by:

Ĥ_{DFT}=F₂ĥ_{DFT}, (10)

where F₂ is a DFT matrix retaining only the first G columns, namely

$${[ {F}_{2} ]}_{p , q} = {e}^{\frac{j 2 π pq}{N}} , for p = 1 , 2 , … , N - 1 and q = 0 , 1 , … , G - 1. \qquad ( 11 )$$

It should be noted that noise reduction may be performed based on that the channel impulse response may comprise at most G taps, and thus all the other samples may correspond to noise. The pilot signal in time domain may be expressed by:

xₚ^{T}=[x₀^{p}, x₁^{p}, . . . , x_{N-1}^{p}]^{T}=Faₚ, (12)

where F is the N×N IDFT matrix, i.e.,

$${[ F ]}_{p , q} = {e}^{\frac{j 2 π pq}{N}} , for p = 0 , 1 , … , N - 1 and q = 0 , 1 , … , N - 1. \qquad ( 13 )$$

The vector a_{P} from equation (12) may be a N×1 vector constructed by retaining the symbols at the pilot subcarriers and setting zeros to the other subcarriers, namely:

$${a}_{p} = {[ {a}_{0} , \underbrace{0 , … , 0 ,}_{{D}_{f} - 1} {a}_{1} , … , {a}_{M - 1} , 0 , … , 0 ]}^{T} . \qquad ( 14 )$$

According to certain aspects, for the l-th channel tap, E[|ĥₗ−hₗ(n)|²] may be minimized for n=(N/2−1). Therefore, by approximating hₗ(N/2−1) with the estimate of ĥₗ, the following may be true:

$${\hat{h}}_{l} ( \frac{N}{2} - 1 ) = \hat{{h}_{l}} . \qquad ( 15 )$$

If the linearization is considered around hₗ(N/2−1), ĥₗ(n) may be approximated by using linear interpolation between adjacent symbols as follows:

$$\begin{matrix}{\hat{h}}_{l} ( n ) \approx \frac{\frac{N}{2} - n - 1}{N + G} {\hat{h}}_{l}^{previous} ( \frac{N}{2} - 1 ) + \frac{\frac{N}{2} + G + n + 1}{N + G} {\hat{h}}_{l} ( \frac{N}{2} - 1 ) 0 \leq n \leq \frac{N}{2} - 2 \\ and & ( 16 ) \\ {\hat{h}}_{l} ( n ) \approx \frac{\frac{3 N}{2} + G - n - 1}{N + G} {\hat{h}}_{l} ( \frac{N}{2} - 1 ) + \frac{n - \frac{N}{2} + 1}{N + G} {\hat{h}}_{l}^{next} ( \frac{N}{2} - 1 ) \frac{N}{2} \leq n \leq N - 1. & ( 17 )\end{matrix}$$

where ĥₗ^{previous}(N/2−1) and ĥₗ^{next}(N/2−1) denote the estimates of the channel at midpoint of the previous and next symbols, respectively. Based on equation (14) and above analysis, these midpoint channel estimates may correspond to the l-th elements of CIR vectors in the previous and next symbols, i.e.

$$\begin{matrix}{\hat{h}}_{DFT}^{previous} = {[ {\hat{h}}_{0}^{previous} ( \frac{N}{2} - 1 ) , … , {\hat{h}}_{G - 1}^{previous} ( \frac{N}{2} - 1 ) ]}^{T} = {[ {\hat{h}}_{0}^{previous} , … , {\hat{h}}_{G - 1}^{previous} ]}^{T} \\ and & ( 18 ) \\ {\hat{h}}_{DFT}^{next} = {[ {\hat{h}}_{0}^{next} ( \frac{N}{2} - 1 ) , … , {\hat{h}}_{G - 1}^{next} ( \frac{N}{2} - 1 ) ]}^{T} = {[ {\hat{h}}_{0}^{next} , … , {\hat{h}}_{G - 1}^{next} ]}^{T} & ( 19 )\end{matrix}$$

Under the consideration of channel estimation error and computational complexity, the linear interpolation may be only applied on a set of K selected paths. To perform this, an averaged CIR may be first calculated according to:

$${\hat{h}}_{DFT}^{ave} = {[ {\hat{h}}_{0}^{ave} , … , {\hat{h}}_{G - 1}^{ave} ]}^{T} = \frac{{\hat{h}}_{DFT}^{previous} + {\hat{h}}_{DFT} + {\hat{h}}_{DFT}^{next}}{3} . \qquad ( 20 )$$

Then, the elements of ĥ_{DFT}^{ave} may be sorted according to their amplitudes in descending order, i.e.

ĥ_{DFT}^{ave}=[ĥ_{I}_{₀}^{ave}, . . . ,ĥ_{I}_{_{G-1}}^{ave}]^{T} (21)

and their positions may be stored in a vector I=[I₀, I₁, . . . , I_{G-1}]. The values of the first K elements in the vector I may provide the K path positions, at which the channel estimates may be obtained by using the linear interpolation.

Finally, the received pilot signal in time domain may be reconstructed according to:

$$\begin{matrix}{y}_{n}^{p} = {\sum }_{k = 0}^{K - 1} {\hat{h}}_{{l}_{k}} ( n ) {x}_{{( ( n - {l}_{k} ) )}_{N}}^{p} & 0 \leq n \leq N - 1.\end{matrix} \qquad ( 22 )$$

By subtracting yₙ^{p} directly from yₙ, the ICI generated by the pilot signal may be mitigated effectively.

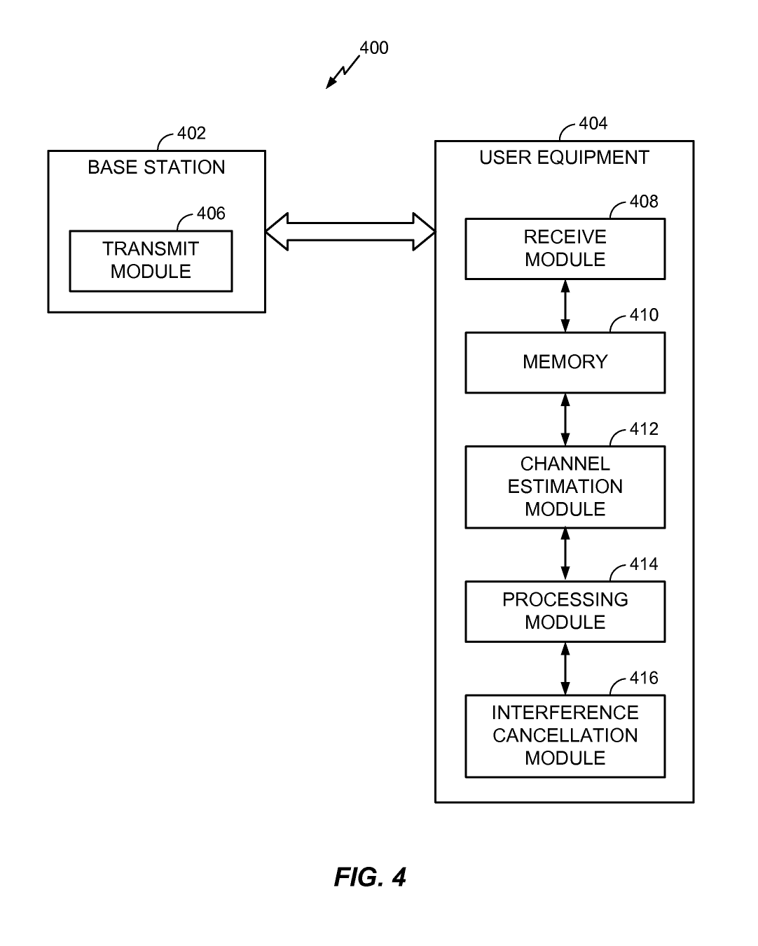

FIG. 4 illustrates an example system 400 that facilitates ICI mitigation in accordance with certain aspects of the present disclosure. The system 400 may comprise an access point 402 (e.g., base station, Node B, eNB, and so on) that may communicate with an access terminal 404 (e.g., UE, mobile station, mobile device, and/or any number of disparate devices (not shown)). The base station 402 may transmit information to the UE 404 over a forward link channel or downlink channel; further the base station 402 may receive information from the UE 404 over a reverse link channel or uplink channel. Moreover, the system 400 may be a multiple-input multiple-output (MIMO) system. Additionally, the system 400 may operate in an OFDMA wireless network (such as 3GPP LTE, LTE-A, and so on). Also, in an aspect, the components and functionalities shown and described below in the base station 402 may be present in the UE 404 and vice versa.

The base station 402 may comprise a transmit module 406 that may transmit a sequence of OFDM symbols, the transmitted OFDM symbols comprising data tones and pilot tones. The UE 404 may comprise a receive module 408 that may be configured to receive a sequence of OFDM symbols transmitted from the base station 402, the received OFDM symbols comprising data tones and pilot tones. The UE 404 may further comprise a memory (or a buffer unit) 410 for storing samples of at least three of the OFDM symbols in the sequence and known pilots, as well as for storing channel estimates associated with the least three OFDM symbols. The UE 404 may further comprise a channel estimation module 412 that may be configured to estimate a channel impulse response (CIR) vector for each of the at least three OFDM symbols, for a plurality of channel paths, based on pilot tones in the at least three OFDM symbols. The channel estimation module 412 may be also configured to obtain, based on the estimated CIR vectors, channel estimates associated with a current one of the at least three OFDM symbols for a set of one or more channel paths from the plurality of channel paths.

The UE 404 may further comprise a processing module 414 that may be configured to obtain a pilot signal based on pilot tones in the current OFDM symbol, wherein the pilot signal covers all tones of the current OFDM symbol. The UE 404 may further comprise an interference cancellation module 416 that may be configured to calculate an estimated received pilot signal based on the obtained pilot signal and the channel estimates associated with the current OFDM symbol for the set of one or more channel paths, and to subtract the estimated received pilot signal from received data tones of the current OFDM symbol.

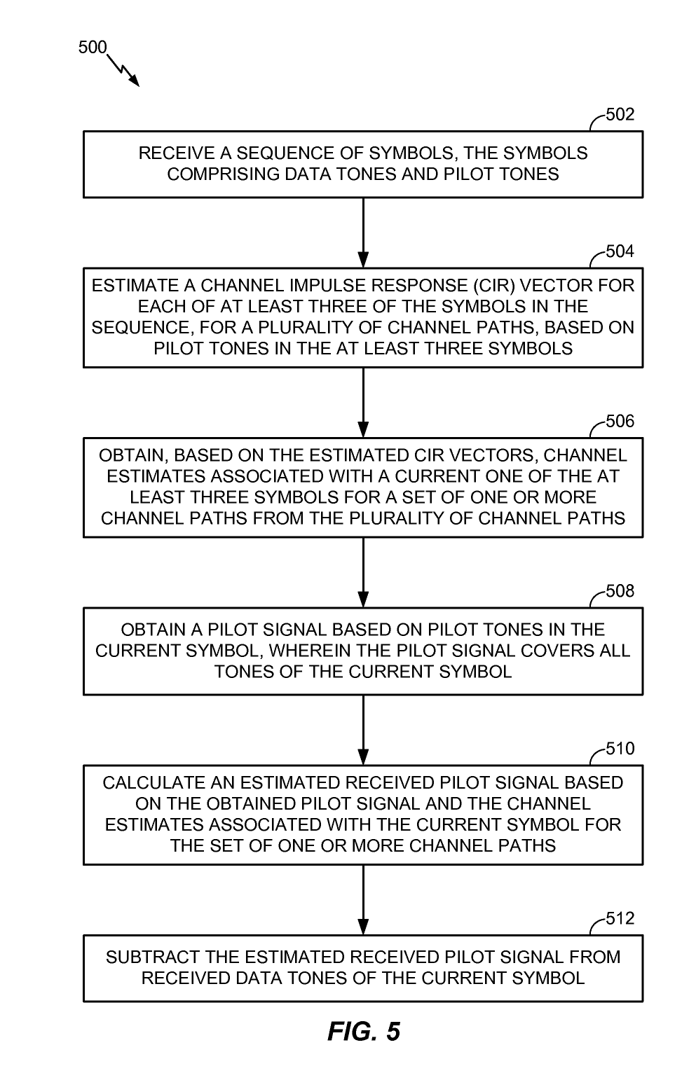

FIG. 5 is a functional block diagram conceptually illustrating example blocks 500 that may be performed at a receiver side of a wireless system for mitigating the ICI in accordance with certain aspects of the present disclosure. Operations illustrated by the blocks 500 may be executed, for example, at the processor 270 of the access terminal 250 from FIG. 2, at the processor 304 of the wireless device 302 from FIG. 3, and/or at the modules 408, 412, 414 and 416 of the UE 404 from FIG. 4.

The operations may begin, at block 502, by receiving a sequence of OFDM symbols, the OFDM symbols comprising data tones and pilot tones. At block 504, a channel impulse response (CIR) vector may be estimated for each of at least three of the OFDM symbols in the sequence, for a plurality of channel paths, based on pilot tones in the at least three OFDM symbols. At block 506, channel estimates associated with a current one of the at least three OFDM symbols may be obtained, based on the estimated CIR vectors, for a set of one or more channel paths from the plurality of channel paths.

At block 508, a pilot signal may be obtained based on pilot tones in the current OFDM symbol, wherein the pilot signal covers all tones of the current OFDM symbol. At block 510, an estimated received pilot signal may be calculated based on the obtained pilot signal and the channel estimates associated with the current OFDM symbol for the set of one or more channel paths. At block 512, the estimated received pilot signal may be subtracted from received data tones of the current OFDM symbol.

In an aspect, an average CIR vector may be obtained by averaging the estimated CIR vectors (e.g., as defined by equation (20)). Then, the set of one or more paths may be selected based on path strengths as indicated by the average CIR vector. In an aspect, selecting the set of one or more paths comprises sorting elements of the average CIR vector according to their amplitudes in descending order to obtain a sorted average CIR vector, and choosing the set of one or more paths based on elements of the sorted average CIR vector.

In one configuration, the apparatus 250 for wireless communication includes means for receiving a sequence of OFDM symbols, the OFDM symbols comprising data tones and pilot tones, means for estimating a CIR vector for each of at least three of the OFDM symbols in the sequence, for a plurality of channel paths, based on pilot tones in the at least three OFDM symbols, means for obtaining, based on the estimated CIR vectors, channel estimates associated with a current one of the at least three OFDM symbols for a set of one or more channel paths from the plurality of channel paths, means for obtaining a pilot signal based on pilot tones in the current OFDM symbol, wherein the pilot signal covers all tones of the current OFDM symbol, means for calculating an estimated received pilot signal based on the obtained pilot signal and the channel estimates associated with the current OFDM symbol for the set of one or more channel paths, and means for subtracting the estimated received pilot signal from received data tones of the current OFDM symbol. In one aspect, the aforementioned means may be the processor 270 configured to perform the functions recited by the aforementioned means. In another aspect, the aforementioned means may be a module or any apparatus (e.g., the apparatus 404 with modules 408, 410, 412, 414, 416 illustrated in FIG. 4) configured to perform the functions recited by the aforementioned means.

### Performance Results

In order to evaluate the error-rate performance of the proposed method for ICI mitigation, some numerical results are presented in the present disclosure. The main simulation parameters for an OFDM system with 16-QAM modulation are chosen as follows: the sampling frequency of 500 kHz, the carrier frequency equals 2.4 GHz, the number of subcarriers is 64 and the guard interval takes the value of eight. Perfect carrier and symbol synchronization can be assumed, and since no channel coding is considered, hard decision can be used to detect the received symbols. The multipath fading channel is modeled by a T-spaced tapped-delay line filter with tap gains generated by the Jakes' method, and the delay profile is shown in Table I.

TABLE I

| Tap | Relative | Relative | Doppler |
|---|---|---|---|
| number | delay (T) | Power (dB) | spectrum |
| 1 | 1 | 0 | Classic |
| 2 | 3 | −2 | Classic |
| 3 | 5 | −6 | Classic |
| 4 | 6 | −10 | Classic |

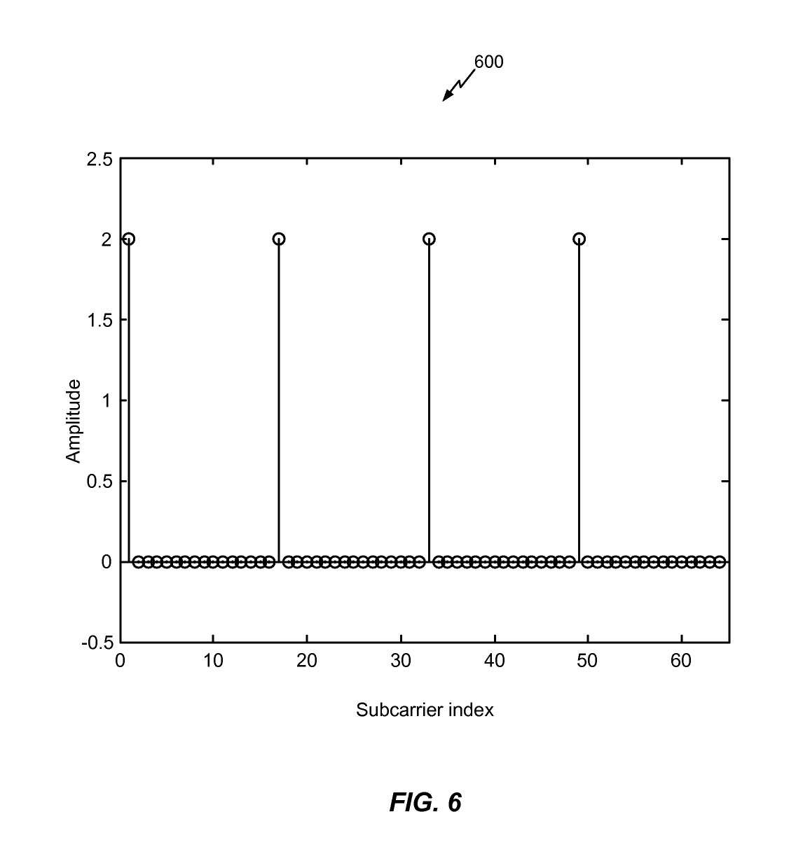

For channel estimation, 16 pilot symbols with energy Eₚ=2Eₛ may be uniformly inserted into data symbols in the frequency domain. If the same QPSK constellation with normalized energy is used, the pilot signal in time domain may have a form 600 illustrated in FIG. 6. It can be observed from FIG. 6 that the computational complexity may be reduced dramatically by performing the linear interpolation and signal reconstruction only on the non-zero samples.

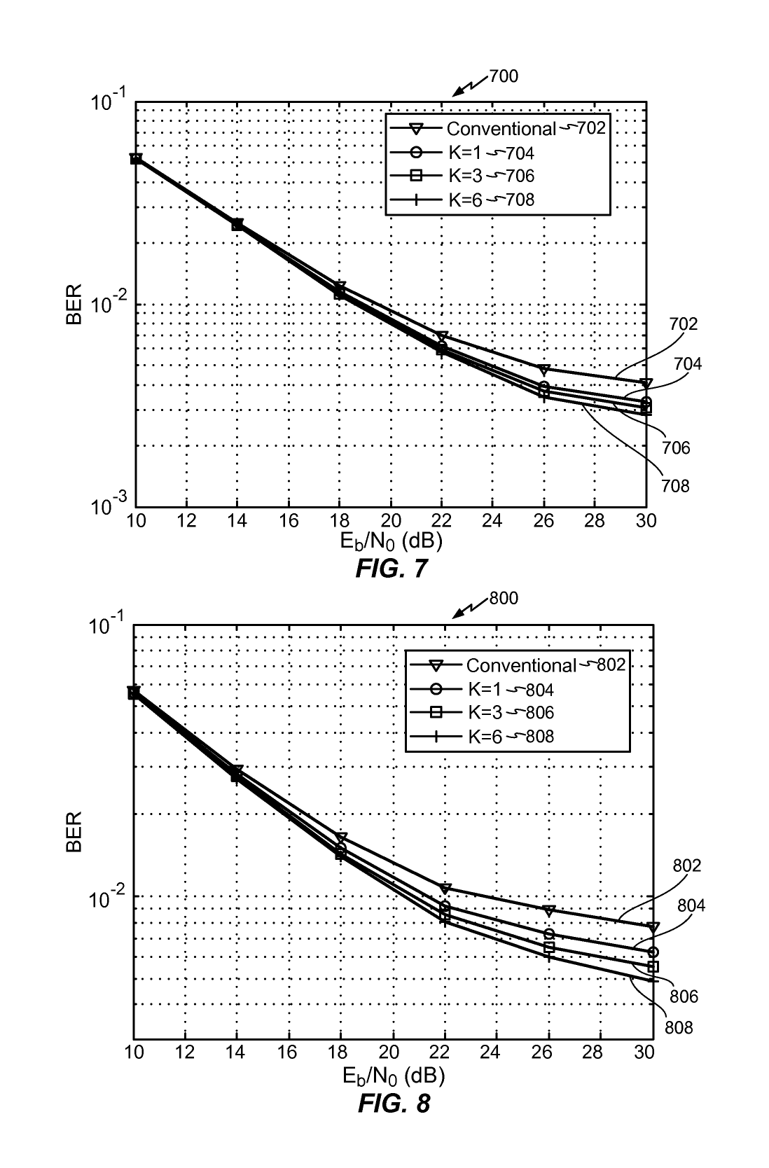

FIG. 7 illustrates an example 700 of bit error rate (BER) performance of the proposed ICI cancellation technique as a function of signal-to-noise ratio (SNR) in a time-varying channel where the maximum Doppler frequency is set to be 200 Hz. It can be observed from FIG. 7 that as the number of selected paths K increases, better BER performance may be obtained (i.e., BER plot 708 for K=6 vs. BER plot 706 for K=3 vs. BER plot 704 for K=1).

FIG. 8 illustrates an example 800 of BER performance of the proposed ICI cancellation technique as a function of SNR in a time-varying channel where the maximum Doppler frequency is set to be 300 Hz. It can be again observed from FIG. 8 that as the number of selected paths K increases, better BER performance may be obtained (i.e., BER plot 808 for K=6 vs. BER plot 806 for K=3 vs. BER plot 804 for K=1). Furthermore, it can be observed from FIG. 7 and FIG. 8 that the gap between the proposed scheme and the conventional method in which no pilot cancellation is employed may become larger with the increase of maximum Doppler frequency (e.g., the gap between BER plots 808 and 802 in FIG. 8 is larger than the gap between BER plots 708 and 702 in FIG. 7).

To summarize, certain aspects of the present disclosure can effectively improve performance of an OFDM receiver. The proposed method can be utilized in a practical OFDM system such as LTE downlink, WiMAX and LTE-A due to a low implementation complexity and robust performance. The proposed approach may represent a good tradeoff between computational complexity and system performance, and may be extended to the mitigation of ICI generated by any known symbols in single-input single-output (SISO) OFDM systems or multiple-input multiple-output (MIMO) OFDM systems.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, a phrase referring to “at least one of” a list of items refers to any combination of those items, including single members. As an example, “at least one of: a, b, or c” is intended to cover: a, b, c, a-b, a-c, b-c, and a-b-c.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications, comprising:
receiving a sequence of Orthogonal Frequency Division Multiplexing (OFDM) symbols, the OFDM symbols comprising data tones and pilot tones;
estimating a channel impulse response (CIR) vector for each of at least three of the OFDM symbols in the sequence, for a plurality of channel paths, based on pilot tones in the at least three OFDM symbols;
obtaining, based on the estimated CIR vectors, channel estimates associated with a current one of the at least three OFDM symbols for a set of one or more channel paths from the plurality of channel paths;
obtaining a pilot signal based on pilot tones in the current OFDM symbol, wherein the pilot signal covers all tones of the current OFDM symbol;
calculating an estimated received pilot signal based on the obtained pilot signal and the channel estimates associated with the current OFDM symbol for the set of one or more channel paths; and
subtracting the estimated received pilot signal from received data tones of the current OFDM symbol.

2. The method of claim 1, further comprising:
averaging the estimated CIR vectors to obtain an average CIR vector; and
selecting the set of one or more paths based on path strengths as indicated by the average CIR vector.

3. The method of claim 2, wherein selecting the set of one or more paths comprises:
sorting elements of the average CIR vector according to their amplitudes in descending order to obtain a sorted average CIR vector; and
choosing the set of one or more paths based on elements of the sorted average CIR vector.

4. The method of claim 1, wherein the CIR vector is estimated according to a discrete Fourier transform (DFT) based estimation method.

5. The method of claim 1, wherein the channel estimates are obtained based on the CIR vectors using linear interpolation between the at least three OFDM symbols.

6. The method of claim 1, wherein:
one of the channel estimates for each path from the set is approximated with an element of the CIR vector for the current OFDM symbol, and
the element corresponds to that path from the set.

7. The method of claim 1, wherein:
each of the OFDM symbols comprises a cyclic prefix (CP), and
a length of the CIR vector is equal to a length of the CP.

8. The method of claim 1, wherein estimating the CIR vector comprises:
calculating channel estimates at pilot subcarriers of that OFDM symbol according to Least Square (LS) criterion using received pilot tones and known pilots; and
obtaining the CIR vector using the channel estimates at pilot subcarriers according to a discrete Fourier transform (DFT) based estimation method.

9. The method of claim 1, wherein obtaining the pilot signal comprises:
constructing a vector by retaining values at pilot subcarriers of the current OFDM symbol and by setting zeros to data subcarriers of the current OFDM symbol; and
applying inverse discrete Fourier transform (IDFT) on the constructed vector to generate the pilot signal.

10. An apparatus for wireless communications, comprising:
a receiver configured to receive a sequence of Orthogonal Frequency Division Multiplexing (OFDM) symbols, the OFDM symbols comprising data tones and pilot tones;
an estimator configured to estimate a channel impulse response (CIR) vector for each of at least three of the OFDM symbols in the sequence, for a plurality of channel paths, based on pilot tones in the at least three OFDM symbols;
a first circuit configured to obtain, based on the estimated CIR vectors, channel estimates associated with a current one of the at least three OFDM symbols for a set of one or more channel paths from the plurality of channel paths;
a second circuit configured to obtain a pilot signal based on pilot tones in the current OFDM symbol, wherein the pilot signal covers all tones of the current OFDM symbol;
a third circuit configured to calculate an estimated received pilot signal based on the obtained pilot signal and the channel estimates associated with the current OFDM symbol for the set of one or more channel paths; and
a fourth circuit configured to subtract the estimated received pilot signal from received data tones of the current OFDM symbol.

11. The apparatus of claim 10, further comprising:
a fifth circuit configured to average the estimated CIR vectors to obtain an average CIR vector; and
a sixth circuit configured to select the set of one or more paths based on path strengths as indicated by the average CIR vector.

12. The apparatus of claim 11, wherein the sixth circuit is also configured to:
sort elements of the average CIR vector according to their amplitudes in descending order to obtain a sorted average CIR vector; and
choose the set of one or more paths based on elements of the sorted average CIR vector.

13. The apparatus of claim 10, wherein the CIR vector is estimated according to a discrete Fourier transform (DFT) based estimation method.

14. The apparatus of claim 10, wherein the channel estimates are obtained based on the CIR vectors using linear interpolation between the at least three OFDM symbols.

15. The apparatus of claim 10, wherein:
one of the channel estimates for each path from the set is approximated with an element of the CIR vector for the current OFDM symbol, and
the element corresponds to that path from the set.

16. The apparatus of claim 10, wherein:
each of the OFDM symbols comprises a cyclic prefix (CP), and
a length of the CIR vector is equal to a length of the CP.

17. The apparatus of claim 10, wherein the estimator is also configured to:
calculate channel estimates at pilot subcarriers of that OFDM symbol according to Least Square (LS) criterion using received pilot tones and known pilots; and
obtain the CIR vector using the channel estimates at pilot subcarriers according to a discrete Fourier transform (DFT) based estimation method.

18. The apparatus of claim 10, wherein the second circuit is also configured to:
construct a vector by retaining values at pilot subcarriers of the current OFDM symbol and by setting zeros to data subcarriers of the current OFDM symbol; and
apply inverse discrete Fourier transform (IDFT) on the constructed vector to generate the pilot signal.

19. An apparatus for wireless communications, comprising:
means for receiving a sequence of Orthogonal Frequency Division Multiplexing (OFDM) symbols, the OFDM symbols comprising data tones and pilot tones;
means for estimating a channel impulse response (CIR) vector for each of at least three of the OFDM symbols in the sequence, for a plurality of channel paths, based on pilot tones in the at least three OFDM symbols;
means for obtaining, based on the estimated CIR vectors, channel estimates associated with a current one of the at least three OFDM symbols for a set of one or more channel paths from the plurality of channel paths;
means for obtaining a pilot signal based on pilot tones in the current OFDM symbol, wherein the pilot signal covers all tones of the current OFDM symbol;
means for calculating an estimated received pilot signal based on the obtained pilot signal and the channel estimates associated with the current OFDM symbol for the set of one or more channel paths; and
means for subtracting the estimated received pilot signal from received data tones of the current OFDM symbol.

20. The apparatus of claim 19, further comprising:
means for averaging the estimated CIR vectors to obtain an average CIR vector; and
means for selecting the set of one or more paths based on path strengths as indicated by the average CIR vector.

21. The apparatus of claim 20, wherein the means for selecting the set of one or more paths comprises:
means for sorting elements of the average CIR vector according to their amplitudes in descending order to obtain a sorted average CIR vector; and
means for choosing the set of one or more paths based on elements of the sorted average CIR vector.

22. The apparatus of claim 19, wherein the CIR vector is estimated according to a discrete Fourier transform (DFT) based estimation method.

23. The apparatus of claim 19, wherein the channel estimates are obtained based on the CIR vectors using linear interpolation between the at least three OFDM symbols.

24. The apparatus of claim 19, wherein:
one of the channel estimates for each path from the set is approximated with an element of the CIR vector for the current OFDM symbol, and
the element corresponds to that path from the set.

25. The apparatus of claim 19, wherein:
each of the OFDM symbols comprises a cyclic prefix (CP), and
a length of the CIR vector is equal to a length of the CP.

26. The apparatus of claim 19, wherein the means for estimating the CIR vector comprises:
means for calculating channel estimates at pilot subcarriers of that OFDM symbol according to Least Square (LS) criterion using received pilot tones and known pilots; and
means for obtaining the CIR vector using the channel estimates at pilot subcarriers according to a discrete Fourier transform (DFT) based estimation method.

27. The apparatus of claim 19, wherein the means for obtaining the pilot signal comprises:
means for constructing a vector by retaining values at pilot subcarriers of the current OFDM symbol and by setting zeros to data subcarriers of the current OFDM symbol; and
means for applying inverse discrete Fourier transform (IDFT) on the constructed vector to generate the pilot signal.

28. A computer program product, comprising a computer-readable medium comprising code for:
receiving a sequence of Orthogonal Frequency Division Multiplexing (OFDM) symbols, the OFDM symbols comprising data tones and pilot tones;
estimating a channel impulse response (CIR) vector for each of at least three of the OFDM symbols in the sequence, for a plurality of channel paths, based on pilot tones in the at least three OFDM symbols;
obtaining, based on the estimated CIR vectors, channel estimates associated with a current one of the at least three OFDM symbols for a set of one or more channel paths from the plurality of channel paths;
obtaining a pilot signal based on pilot tones in the current OFDM symbol, wherein the pilot signal covers all tones of the current OFDM symbol;
calculating an estimated received pilot signal based on the obtained pilot signal and the channel estimates associated with the current OFDM symbol for the set of one or more channel paths; and
subtracting the estimated received pilot signal from received data tones of the current OFDM symbol.

29. The computer program product of claim 28, wherein the computer-readable medium further comprising code for:
averaging the estimated CIR vectors to obtain an average CIR vector; and
selecting the set of one or more paths based on path strengths as indicated by the average CIR vector.

30. The computer program product of claim 29, wherein the computer-readable medium further comprising code for:
sorting elements of the average CIR vector according to their amplitudes in descending order to obtain a sorted average CIR vector; and
choosing the set of one or more paths based on elements of the sorted average CIR vector.

31. The computer program product of claim 28, wherein the CIR vector is estimated according to a discrete Fourier transform (DFT) based estimation method.

32. The computer program product of claim 28, wherein the channel estimates are obtained based on the CIR vectors using linear interpolation between the at least three OFDM symbols.

33. The computer program product of claim 28, wherein:
one of the channel estimates for each path from the set is approximated with an element of the CIR vector for the current OFDM symbol, and
the element corresponds to that path from the set.

34. The computer program product of claim 28, wherein:
each of the OFDM symbols comprises a cyclic prefix (CP), and
a length of the CIR vector is equal to a length of the CP.

35. The computer program product of claim 28, wherein the computer-readable medium further comprising code for:
calculating channel estimates at pilot subcarriers of that OFDM symbol according to Least Square (LS) criterion using received pilot tones and known pilots; and
obtaining the CIR vector using the channel estimates at pilot subcarriers according to a discrete Fourier transform (DFT) based estimation method.

36. The computer program product of claim 28, wherein the computer-readable medium further comprising code for:
constructing a vector by retaining values at pilot subcarriers of the current OFDM symbol and by setting zeros to data subcarriers of the current OFDM symbol; and
applying inverse discrete Fourier transform (IDFT) on the constructed vector to generate the pilot signal.
